(19) United States
(12) Patent Application Publication
(10) Pub. No.: US 2010/0089427 A1
(43) Pub. Date: Apr. 15, 2010

(54) SOLAR CAR WASH

(76) Inventor: Albert Norman Wesson, Benoni (ZA)

Correspondence Address: BANNER & WITCOFF, LTD., 1100 13th STREET, N.W., SUITE 1200, WASHINGTON, DC, 20005-4051, US

(21) Appl. No.: 11/993,752

(22) PCT Filed: Jun. 23, 2006
(86) PCT No.: PCT/ZA2006/000084

§ 371 Date: Dec. 9, 2009

(30) Foreign Application Priority Data
Jun. 23, 2005 (ZA) 2005/05085

(51) Int. Cl. B08B 3/04

(52) U.S. Cl. 134/104.2

(57) ABSTRACT

An electrically driven washing apparatus for washing especially cars and other vehicles, adapted for suitability in a franchise operation, where the machines are hired to franchisees and suitable controls are inherent in the design and operation of the apparatus, also adapted for in-parkade washing with collection of run-off water and storage for later disposal.

### BACKGROUND OF THE INVENTION

This invention relates to an electrical driven washing apparatus which is Portable and which is particularly suited for the washing of vehicles. It is to be understood, however, that although the invention is described hereinafter with reference to the washing of vehicles the scope of the invention is not confined to this particular application and, in general terms, the apparatus of the invention can readily be used for other applications e.g. the washing of windows, floors, etc.

A vehicle owner who wished to clean his vehicle either does the work himself or makes use of a third party. Most vehicle owners do not have the inclination to wash their own vehicles. Many of these people make use of the services of an automated car wash. Facilities of this kind are located in out of the way places and a vehicle owner might spend a considerable period queuing before his vehicle can be washed. There is also the belief that the brushes which are used can damage the paint work of a vehicle.

Shopping centres may have a number of operators who wash with buckets. The water which is used is often dirty. Inferior soap and dirty rags make the end result, a vehicle which is not properly cleaned.

Furthermore these are currently pressurized units operating in car parks, which have short falls. Leaving water in the car parks can cause injuries by the public slipping on soapy water. In multi story car parks the floors are not solid and water drips through floors rusting reinforcing which could collapse the building. Municipalities do not want water to run into storm water drains but municipal drains. As water conservation is a world wide concern most vehicle owners would like to see water recycled. There are major discrepancies between franchise owners and operators on how many vehicles have been washed. There is some concern that the current units are pressure vessels therefore need test certificates as they operate at three bars plus.

### SUMMARY OF THE INVENTION

The invention is concerned with an electrical washing apparatus which includes a set of wheels, a cabinet which is fixed to the wheels. Two tanks one for clean water and one for dirty water.

A water inlet to clean water tank, which in turn houses an electric pump that is run by a battery through an inverter or direct.

The battery is charged by a solar panel.

The water from clean water tank is pumped by electric pump though the outlet into extension pipe and then through spray gun.

A wax stick which contains cleaning chemicals and wax is placed into spray gun for soapy water.

To the clean water tank a water lever gauge is fixed, showing water level in tank.

The dirty water tank has an inlet for dumping dirty water into tank and an outlet valve for dumping dirty water into municipal drains.

The cabinet has a chamber for housing water traps which catches excess water from the car wash.

Furthermore the cabinet has two doors, one door houses cleaning material and the other door give access to electrics ext for maintenance.

The wheels may include fixed pivotal or castor wheels. In a preferred arrangement there are two wheels which are fixed to the cabinet and two wheels which are pivotal relatively to the tank. The latter wheels may be mounted on castors. The cabinet may be mounted to the frame in any appropriate way and preferably is attached by a chassis or moulding which is part of the cabinet.

The cabinet and tanks may have any suitable shape. In one example of the invention the tank is circular or square and it is positioned to fit cabinet.

The cabinet or tank may be made out of any appropriate material e.g. plastic, stainless steel or any non corrosive material.

The piping of the unit is made up of a pipe running out of the clean water tank through a inline filter and connected to a 12v d.c. pump (alternately a submergible pump can be used). From the outlet of pump a further pipe is connected to a “T” piece, on one end of “T” piece an operator's hose is attached with a spray gun. To the other end of “T” piece a pipe is fixed to a valve, and in turn a further pipe returns to the clean water tank. When filling the tank the valve is open when operating the unit the valve is shut.

In a control panel which can slide in and out of the machine by means of rails, a key lock is attached. The control panel houses a battery which is connected to an on/off switch with a set of L.E.D. indication lights.

To the (on) side of the switch a relay timer is fitted which is connected to a push button switch which operates the pump and counter. The solar panel is also fixed to the on side of the switch. To the off side of the switch the battery charger is connected.

The water trap system is made up of eight trays, four with one type of configuration and another four with a different configuration.

All the trays are created with angels in them so that when stacked, a minimum of space is taken up when stored in machine.

The two trays can slide in and out for adjustment when placed between vehicles wheels.

Two flat flexible members are clipped into each other to give maximum reach and minimum storage space.

On each side of the flexible members, a rubber is fixed running on both sides the full length of the flexible members.

### BRIEF DESCRIPTION OF THE DRAWINGS

The invention further described by way of example with reference to the accompanying drawings in which:

FIG. 1: is a side view of apparatus

FIG. 2: is a back view of apparatus

FIG. 3: is a front view of apparatus

FIG. 4: is a plan view of apparatus

FIG. 5: is a side view showing advertising

FIG. 6: is a back view showing advertising

FIG. 7: is a front view of piping

FIG. 8: is a plan view of electrics

FIG. 9: is a side view of female trap

FIG. 10: is a front view of female trap

FIG. 11: is a plan view of female trap

FIG. 12: is a side view of male trap

FIG. 13: is a front view of male trap

FIG. 14: is a plan view of male trap

FIG. 15: is a plan view of male arch

FIG. 16: is a side view of male arch

FIG. 17: is a plan view of female arch

FIG. 18: is a side view of female arch

FIG. 19: is a assembly of water traps

### DESCRIPTION OF PREFERRED EMBODIMENT

The accompanying drawings illustrate the electrical driven washing apparatus. According to the invention which is particularly suited for the washing of motor vehicles.

The apparatus includes a cabinet 4 to the cabinet 4, a pair of fixed wheels 2 and a pair of swivel wheels 3 are attached by means of a chassis 1 into cabinet 4 a door 6 is fixed by means of hinges 5. In turn handles 7 is attached with a lock 9.

Into the cabinet 4 a clean water tank 10 and a dirty water tank 11 is placed. To the dirty water tank 11 an inlet 12 is fixed protruding through cabinet 4, a valve 13 is placed at the bottom of tank 11.

A solar panel 8 is fixed to the top of the cabinet 4.

A hole is cut out of cabinet 4 which house a coil up hose 21. Controls start switch 34 and direction valve 18 is fixed to cabinet 4.

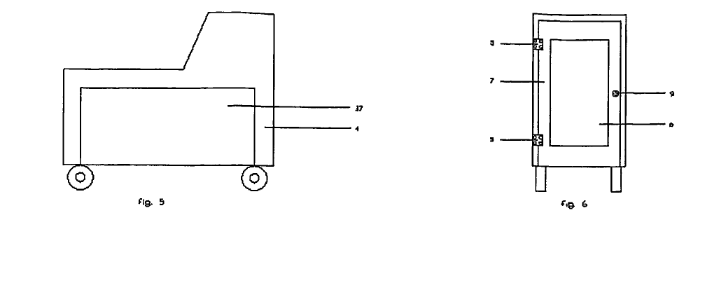

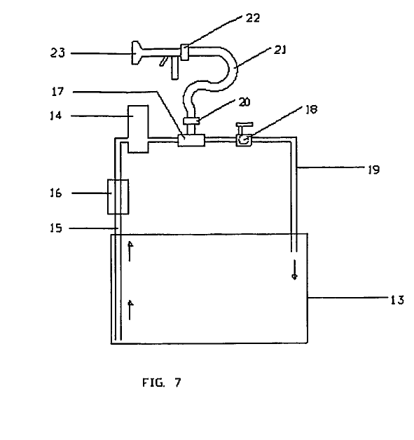

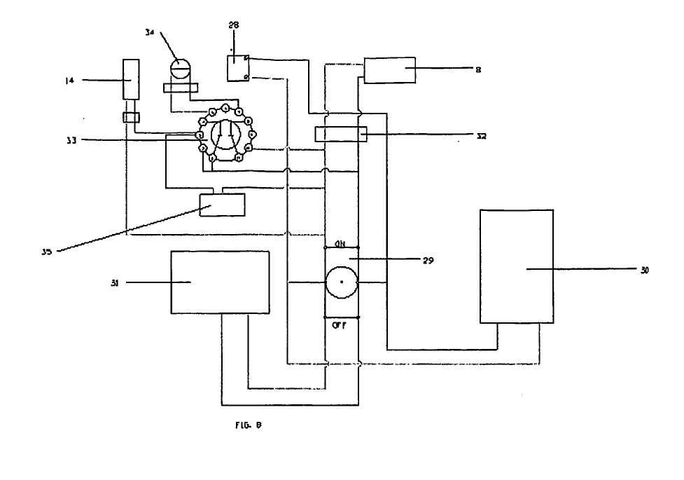

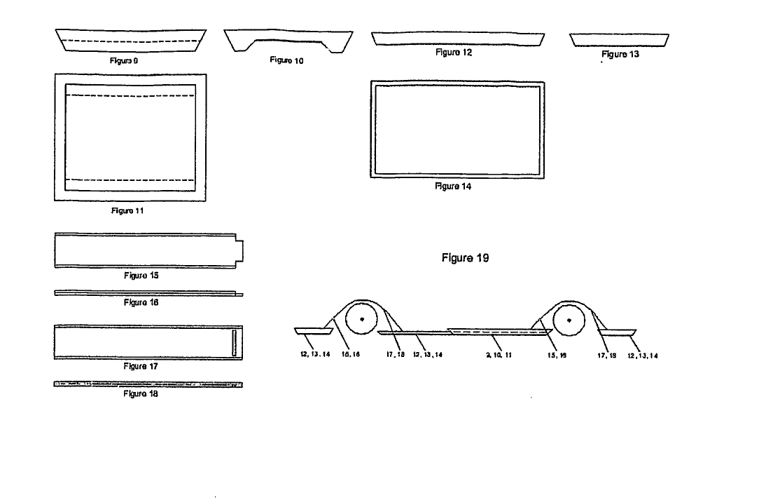

Inside the cabinet 4 a shelf 27 is fixed with a set of rails 26 is attached and in turn attached to cabinet 25. The water traps FIG. 9 to 15 and step ladder 36 are housed on tanks 10, 11 when not in use.

From the clean water tank 10 a pipe 15 is connected to a filter 16, then 165 from filter 16 to pump 14. From pump 14 a “T” piece 17 is attached. To one end of “T” piece 17 a coil hose 21 is placed with a spray gun 22 by means of tap adaptors 20, 22. To the other end of “T” piece 17 a valve 18 is attached with a further pipe 19 returning to tank 13.

Two handles 7 are fixed to cabinet 4. The electrics are house in a control box 24 which runs on rails 26 and in turn is attached to a fixed shelf 27. Battery 28 and battery monitor 30 is connected to in supply of on/off switch 29.

From the one side of on/off switch 29, a relay timer 33 and solar panel 8 is connected. The counter 35 positive is connected to relay timer 33 and negative to one side of on/off switch 29.

The pump 14 is connected to relay timer 33 and the negative to one side of on/off switch 29. A press button switch 34 is connected to the relay timer 33. Battery charger 31 is connected to off side of on/off switch 29.

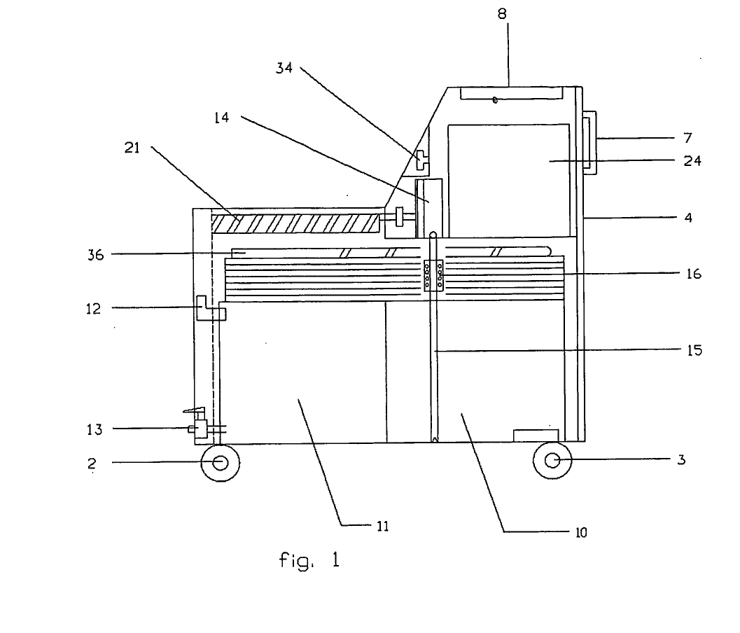

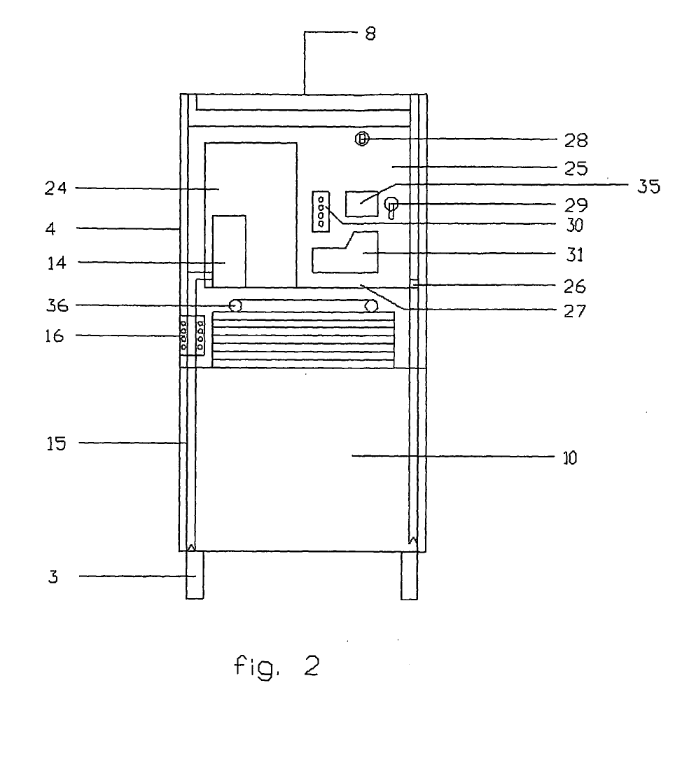

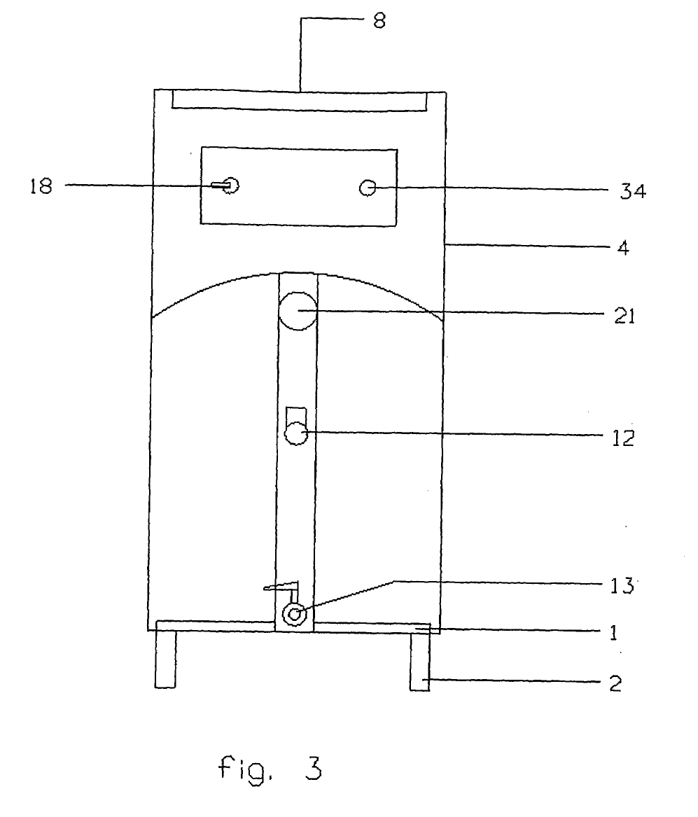

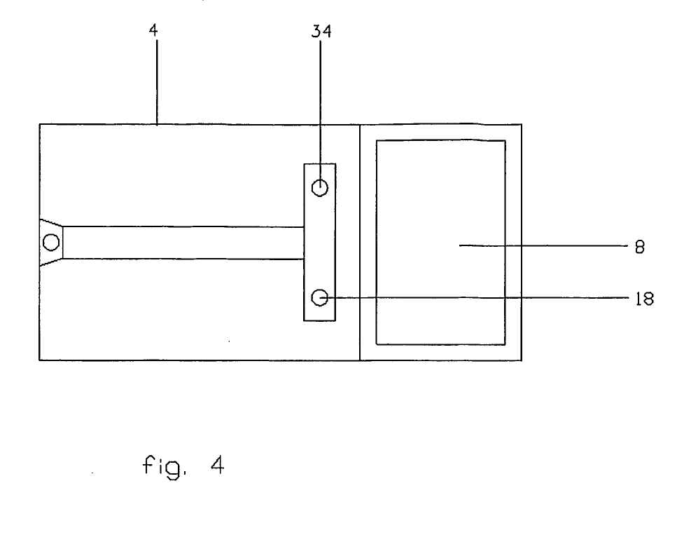

FIG. 19 shows water trap ass FIG. 9, 10, 11, 12, 15, 14, 15, 16, 17, 18. Where FIG. 2 can slide under FIG. 1 for adjustment. FIG. 6 and FIG. 3 clip into each other.

FIG. 5 shows an indentation 37 on cabinet 4 which allows for advertising.

1. An electrical driven washing apparatus comprising:
a set of wheels;
a cabinet fixed to the set of wheels;
two tanks, one for clean water and one for dirty water;
a water inlet to the clean water tank;
an electric pump housed in the clean water tank;
an electrical connection via an inverter to a battery or to an external source of power;
a solar panel to charge the battery;
an outlet from the clean water tank to a spray gun;
a wax stick which contains cleaning chemicals and wax placed in the spray gun for soapy water;
an inlet for the dirty water tank for dumping dirty water into the tank; and
an outlet for dumping dirty water into external drains.

2. A washing apparatus as claimed in claim 1, which has a water level gauge to show water level in the tank.

3. A washing apparatus as claimed in claim 1, which has a chamber for housing water traps which catch excess water from the wash.

4. A washing apparatus as claimed in claim 1, which has a cabinet with two doors, one for housing cleaning material and the other to give access to electrical components and other items for maintenance.

5. A washing apparatus as claimed in claim 1, which has two fixed and two pivotal or castor wheels.

6. A washing apparatus as claimed in claim 1, which has a pipe running out of the clean water tank through an in line filter connected to a pump, from the outlet of the pump a further pipe leading to a tee piece with an operator's hose connected at one end of the tee to the spray gun and the other end of the tee piece connected to a further pipe which returns to the clean water tank, with a valve.

7. A washing apparatus as claimed in claim 4, in which a control panel is provided that can slide in and out of the cabinet, with a key lock, with a battery and l.e.d indication lights.

8. A washing apparatus as claimed in claim 1, which has a relay timer connected to a push button which operates the pump and a counter.

9. A washing apparatus as claimed in claim 1, provided in combination with a plurality of trays, including a first set and a second set, all trays provided with forms that allow compact stacking, the trays for capturing water run-off from an object being washed.

10. A washing apparatus as herein described and as illustrated in the drawings.
